(19) United States
(12) Patent Application Publication
(10) Pub. No.: US 2009/0153499 A1
(43) Pub. Date: Jun. 18, 2009

(54) TOUCH ACTION RECOGNITION SYSTEM AND METHOD

(75) Inventors: Jae Hong KIM, Daejeon (KR); Sang Seung Kang, Daejeon (KR); Joo Chan Sohn, Daejeon (KR); Hyun Kyu Cho, Daejeon (KR); Young-Jo Cho, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/190,760

(22) Filed: Aug. 13, 2008

(30) Foreign Application Priority Data
Dec. 18, 2007 (KR) 10-2007-0133421

(51) Int. Cl. G06F 3/041

(52) U.S. Cl. 345/173

(57) ABSTRACT

A system for recognizing a touch action that a person has performed upon an object, is provided with a sensor component for detecting a sensor value corresponding to the touch action through an inertial sensor attached to part of a body of the person; and a signal processing component for recognizing the touch action from the sensor value detected by the sensor component and transferring the recognized touch action to the object. Further, a method for recognizing a touch action that a person has performed upon an object, is provided with: detecting a sensor value corresponding to the touch action through an inertial sensor attached to part of a body of the person; and recognizing the touch action from the detected sensor value and transferring the recognized touch action to the object.

### CROSS-REFERENCE(S) TO RELATED APPLICATIONS

The present invention claims priority of Korean Patent Application No. 10-2007-0133421, filed on Dec. 18, 2007, which is incorporated herein by reference

### FIELD OF THE INVENTION

The present invention relates to a touch action (or gesture) recognition system and method, and more particularly to a system and method for recognizing touch actions that a person has performed upon an object.

This work was supported by the IT R&D program of MIC/IITA. [2006-S-026-02, Development of the URC Server Framework for Proactive Robotic Services]

### BACKGROUND OF THE INVENTION

The term “touch action recognition” refers to determination of an action such as “hit,” “stroke,” “scratch,” “tickle,” or “poke” that may occur when a hand of a person touches an object (specifically, a robot). A system including an apparatus for recognizing a touch action (for example, stroking of a head of a robot by a hand of a person) is referred to as a “touch action recognition system” and a method for the same is referred to as a “touch action recognition method.”

A touch action recognition system and method is increasingly required as application of robots extends from industrial robots to household robots (especially, pet robots). For example, if the touch action recognition system and method is applied to pet robots such as puppy-like robots that are currently on the market, the robot can determine whether or not a person has performed an action such as “hit,” “stroke,” or “tickle” on the robot. This can elicit various changes in aspects of the robot such as changes in emotion and personality, allowing the robot to express more lifelike reactions to the person. For example, applying the touch action recognition system and method allows the robot to exhibit reactions similar to those of real animals such as feeling threatened and retreating while barking at a person when the person “hits” the robot or looking at a person wearing a happy expression when the person “strokes” the robot.

FIG. 1 illustrates a touch action recognition technology in accordance with a first conventional embodiment.

As shown in FIG. 1, a plurality of touch sensors 21 and 23, each of which detect touching of a hand 10 of a person or a different type of object, are attached respectively to desired locations on a robot 20. This technology recognizes a simple touch action using the touch sensors 21 and 23 attached to the robot 20. When a hand 10 of a person or a different type of object touches the touch sensors 21 and 23, a processing system in the robot 20 detects the touching. This allows the robot 20 to determine whether or not something has touched the robot 20.

FIG. 2 illustrates a touch action recognition technology in accordance with a second conventional embodiment. Components of the second conventional embodiment similar to those of the first conventional embodiment shown in FIG. 1 are denoted by the same reference numerals for ease of explanation.

As shown in FIG. 2, a plurality of 21, 23, and 25, each of which detect touching of a hand 10 of a person or a different type of object, are attached to a robot 20 at positions near a specific location on the robot 20. This is a touch action recognition technology similar to that of the first conventional embodiment. For example, when a hand 10 of a person or a different type of object touches one of the touch sensors 21, 23, and 25, the robot 20 recognizes the touching as “hit,” and, when a hand 10 of a person or a different type of object sequentially touches the touch sensors 21, 23, and 25, the robot 20 recognizes the touching as “stroke.”

FIGS. 3A, 3B, and 3C are photographs illustrating processes for realizing a touch action recognition technology in accordance with a third conventional embodiment.

In this technology, a simple touch sensor which only determines whether or not something has touched the sensor is not employed but rather an array of force sensors 31 which can measure even the magnitude of force applied by touching is attached to an arm of a robot (or doll) to perform touch action recognition as shown in FIGS. 3A to 3C. More specifically, rectangular force sensors 31 are arranged on a round surface as shown in FIG. 3A, a structure 33 is formed on the force sensors 31 as shown in FIG. 3B, and the structure 33 is then covered with a skin 35 as shown in FIG. 3C. Using the force sensors 31 rather than simple touch sensors in this manner enables recognition of various types of touch actions including “tickle” and “poke.”

The conventional touch action recognition technologies described above have the following problems.

First, touch or force sensors must be attached to an object such as a robot, a toy, and a doll. Touch action recognition is impossible when touch or force sensors have not been attached to the object and a processing program for touch action recognition has not been installed.

Second, it is difficult to attach touch or force sensors to an object. Especially, it is more difficult to attach touch or force sensors to an object when it is necessary to attach a structure or a skin to an object over the force sensors as shown in FIGS. 3B and 3C.

Third, it may not be possible to exactly determine whether an object or a hand of a person has touched the sensor in the first and second conventional embodiments. That is, when an object touches a touch sensor, the touch may be recognized as a touch action occurring when a hand of a person touches the touch sensor. In the case of the third conventional embodiment, it is not easy to perform accurate touch action recognition since it may be determined that a hand of a person has touched an object when a skin 35 covered on the object as shown in FIG. 3C is pressed as the object changes posture.

Fourth, the first and second conventional embodiments can recognize a limited number of simple touch actions such as “presence of touch”, “absence of touch”, “stroke” and “hit”.

### SUMMARY OF THE INVENTION

The present invention has been made to overcome the problems of the conventional technologies, and it is an object of the invention to provide a touch action recognition system and method wherein a touch action recognition device including an inertial sensor capable of detecting movement is mounted on a hand of a person rather than on an object to recognize a touch action that the person has performed upon the object. It is another object of the invention to provide a touch action recognition system and method in which fusion (or combination) of different types of sensors such as fusion of an inertial sensor and a touch sensor and fusion of an inertial sensor and an optical sensor is used to recognize actions such as “hit”, “stroke”, “scratch”, “tickle” or “poke” that a person has performed upon an object.

In accordance with a first aspect of the present invention, there is provided a system for recognizing a touch action that a person has performed upon an object, the system including: a sensor component for detecting a sensor value corresponding to the touch action through an inertial sensor attached to part of a body of the person; and a signal processing component for recognizing the touch action from the sensor value detected by the sensor component and transferring the recognized touch action to the object.

In accordance with a second aspect of the present invention, there is provided a method for recognizing a touch action that a person has performed upon an object, the method including: detecting a sensor value corresponding to the touch action through an inertial sensor attached to part of a body of the person; and recognizing the touch action from the detected sensor value and transferring the recognized touch action to the object.

In accordance with the present invention, there is no need to initially attach sensors to a robot and it is possible to exactly determine whether an object or a hand of a person has touched the robot. In addition, in the case of an object with a skin, the skin does not cause erroneous recognition. It is also possible to recognize a wide variety of touch actions.

### BRIEF DESCRIPTION OF THE DRAWINGS

The objects, features and other advantages of the present invention will be more clearly understood from the following detailed description taken in conjunction with the accompanying drawings, in which:

FIG. 1 illustrates a touch action recognition technology in accordance with a first conventional embodiment;

FIG. 2 illustrates a touch action recognition technology in accordance with a second conventional embodiment;

FIGS. 3A, 3B, and 3C are photographs illustrating processes for a touch action recognition technology in accordance with a third conventional embodiment;

FIG. 4 is a basic conceptual diagram of a touch action recognition system in accordance with an embodiment of the invention;

FIG. 5 is a detailed structural diagram of hardware of the touch action recognition system in accordance with an embodiment of the invention;

FIG. 6 illustrates an example where an inertial sensor and a touch sensor are used together in accordance with an embodiment of the invention;

FIG. 7 illustrates an example where an inertial sensor and an optical sensor are used together in accordance with an embodiment of the invention;

FIGS. 8A to 8C are graphs illustrating the advantage of noise removal when the inertial sensor is used together with the touch sensor in accordance with the embodiment of the invention;

FIG. 9 is a block diagram illustrating details of a sensor processor module and a signal processor module in the touch action recognition system in accordance with the embodiment of the invention;

FIG. 10 is a flow chart illustrating a touch action recognition method in accordance with an embodiment of the invention;

FIG. 11 is a flow chart illustrating in more detail post-processing and preprocessing processes shown in FIG. 10; and

FIG. 12 is a flow chart illustrating in more detail touch action recognition and feedback processes shown in FIG. 10.

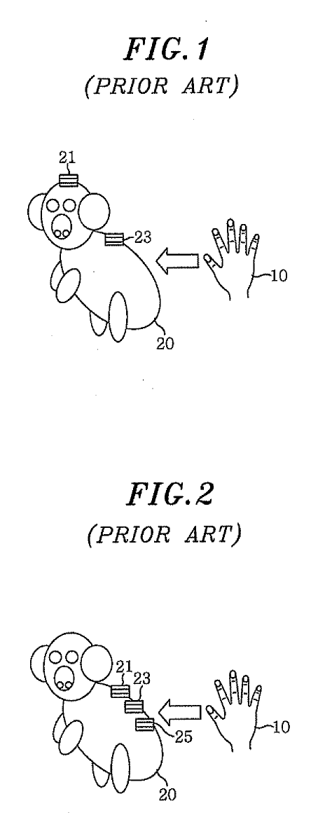

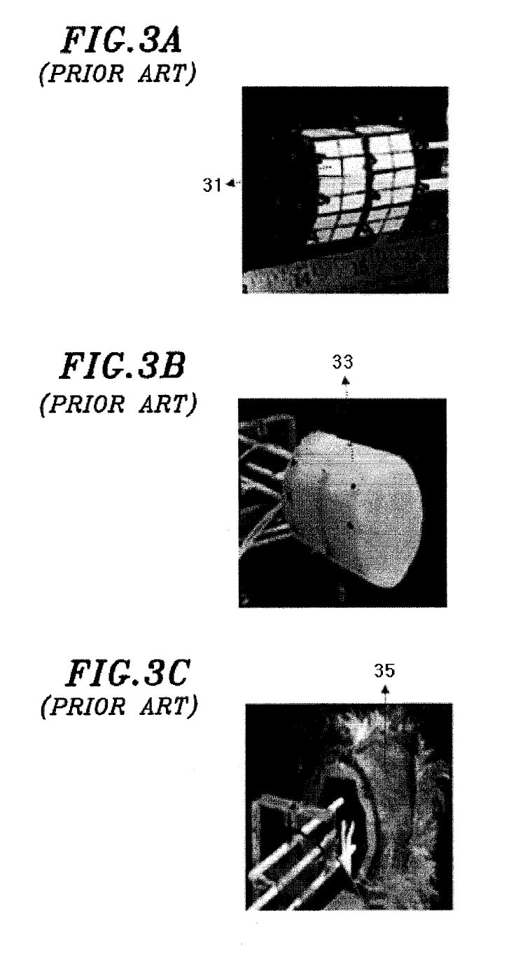

### DETAILED DESCRIPTION OF THE EMBODIMENTS

The preferred embodiments of the present invention will now be described in detail with reference to the accompanying drawings. In the following description of the present invention, a detailed description of known functions and configurations incorporated herein will be omitted when it may obscure the subject matter of the present invention. In the following description, an object that is subjected to touch action recognition in accordance with the invention will be exemplified by a robot for better understanding although the invention can be applied to any other type of object such as a toy or a doll.

The invention uses an inertial sensor alone, or both the inertial sensor and a touch sensor, or both the inertial sensor and an optical sensor in order to sense an action of a person such as “hit”, “stroke”, “scratch”, “tickle” or “poke.” The inertial sensor may be an acceleration sensor that measures acceleration, a gyroscope that measures an angular velocity, or a motion sensor including both the acceleration sensor and the gyroscope.

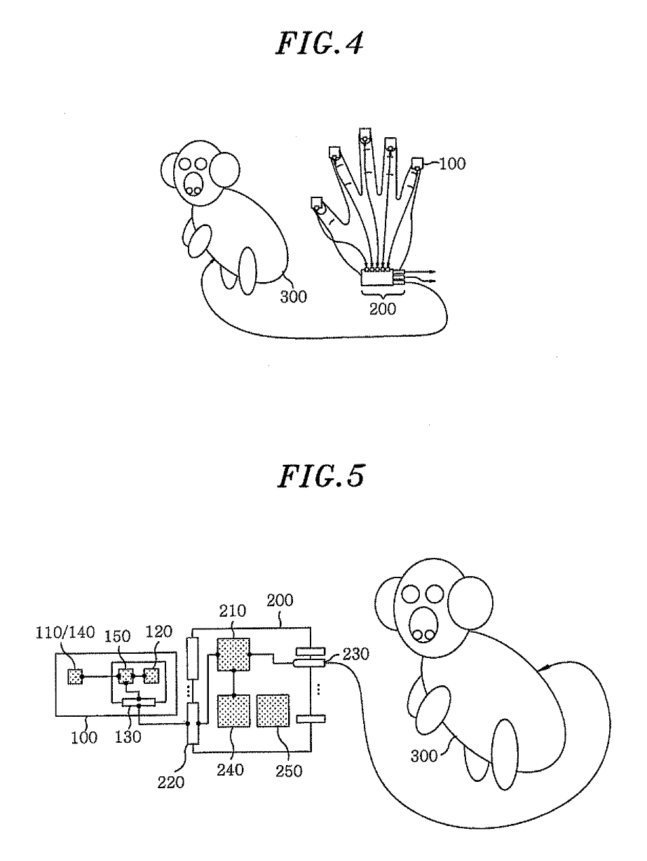

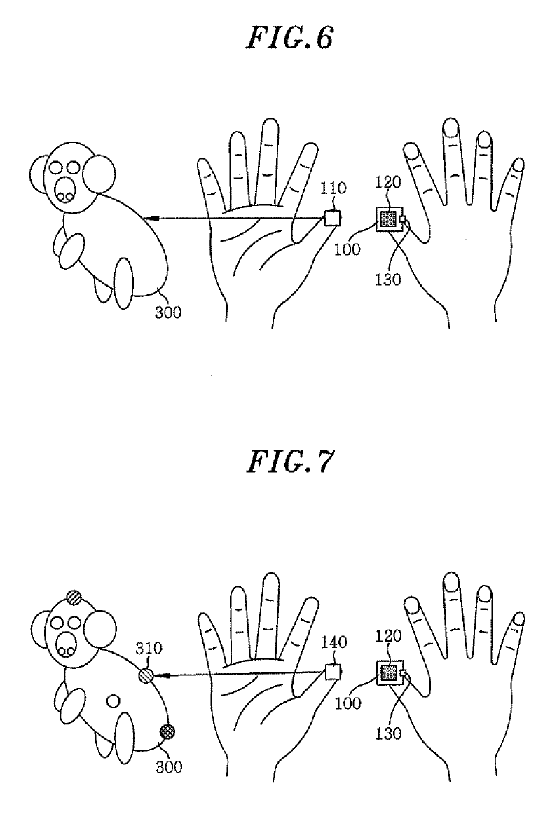

FIG. 4 is a basic conceptual diagram of a touch action recognition system in accordance with an embodiment of the invention, FIG. 5 is a detailed structural diagram of hardware of the touch action recognition system in accordance with an embodiment of the invention, FIG. 6 illustrates an example where the inertial sensor and the touch sensor are used together in accordance with an embodiment of the invention, and FIG. 7 illustrates an example where the inertial sensor and the optical sensor are used together in accordance with an embodiment of the invention.

Configurations and operations of a touch action recognition system in accordance with an embodiment of the invention will now be described in detail with reference to FIGS. 4 to 7.

The touch action recognition system in accordance with the invention includes a sensor board 100, a signal processing board 200, and a robot 300.

At least one sensor board 100 (up to five sensor boards) is attached to fingers of a person. When the person performs a touch action (or gesture) such as “hit”, “tickle”, “stroke”, “poke” or “scratch” on the robot 300, touch, inertial, and optical sensors 110, 120, and 140 in the sensor board 100 produce sensed values corresponding to the action. The sensed values are read through the sensor processor module 150 and are then transmitted to the signal processing board 200 through a sensor interface 130.

The signal processing board 200 is attached, for example, to a wrist of a person. The signal processing board 200 receives sensor data collected at the sensor board 100 through a signal processing interface 220 connected to the sensor interface 130 and performs post-processing, signal preprocessing, and signal processing on the received sensor data through a signal processor module 210 and transmits the processed result as a touch action recognition result such as “hit”, “stroke”, “poke”, “tickle” or “scratch” to the robot 300 through a communication channels 230. The signal processing board 200 also includes a feedback device 240 and a power supply circuit 250. The feedback device 240 allows a person to physically feel a recognition result such as “hit”, “tickle”, “stroke”, “poke” or “scratch.” The power supply circuit 250 supplies power to the signal processing board 200 and the sensor board 100.

The robot 300 receives, through a communication channel (not shown), the touch action recognition result transmitted through the communication channel 230 of the signal processing board 200, which is a signal processing component of the invention, and processes the received touch action recognition result in accordance with a purpose preset in the robot 300.

The inertial sensor 120 is connected to the sensor board 100 or both the inertial sensor 120 and the touch sensor 110 are connected to the sensor board 100 or both the inertial sensor 120 and the optical sensor 140 are connected to the sensor board 100, being a sensor component in accordance with the invention. The inertial sensor 120 may be an acceleration sensor that measures acceleration, a gyroscope that measures an angular velocity, or a motion sensor including both the acceleration sensor and the gyroscope. Although not illustrated, an inertial sensor may be further attached to the wrist of the person to additionally enable recognition of movement of the wrist. When the signal processing board 200 is attached to the wrist of the person as shown in FIG. 4, it is preferable that the inertial sensor for recognizing movement of the wrist be connected to the signal processing board 200 rather than the sensor board 100.

The touch sensor 110 may be any type of sensor such as an on/off touch sensor that can only determine whether or not an object has touched the sensor or a force sensor that can also measure the magnitude of force applied to an object when the object touches the sensor.

The optical sensor 140 is a sensor that can determine the color of an object through the intensity of light reflected from the object.

Each of the sensor processor module 150 and the signal processor module 210 require a memory for data storage and processing. While each of the memory is not separately illustrated or explained, it is assumed in the description of the invention that a memory is included in each of the sensor processor module 150 and the signal processor module 210 since each of the memory is essential for processing of any data. The power supply circuit 250 included in the signal processing board 200 will not be explained in the following description since details of the power supply circuit 250 are similar to those of power supply circuits included in general circuit boards.

The feedback device 240 may be a vibration motor that vibrates at high strength, high frequency and for a long time upon “hitting”, vibrates at normal strength and normal frequency during “tickling,” and vibrates at low strength, low frequency and for a short time upon “stroking.” Although the embodiments of the invention are described with reference to the vibration motor for ease of explanation, a device applying electric current may be used in a modification. The feedback device 240 may be considered as a device that feeds feeling of the robot 300 back to the person in response to a touch action of a person.

The robot 300 may employ any type of control mechanism to allow the robot 300 to exhibit reactions similar to those of real animals. For example, when the robot 300 is pet-shaped, the robot 300 can be designed such that it shows reactions such as feeling threatened and retreating while barking at a person when the person “hits” the robot or looking at a person wearing a happy expression when the person “strokes” the robot. A detailed description of these features of the robot 300 is omitted herein since the invention mainly addresses a touch action recognition technology, applied to generate input signals in order to control the robot, rather than the control mechanism of the robot. Thus, a general description rather than a detailed description will be given of the internal system and the processing flow of the robot 300.

FIG. 6 illustrates an example where the inertial sensor 120 and the touch sensor 110 are used together in accordance with an embodiment of the invention. In this case, it is possible to determine the time when the touch sensor 110 attached to an inner surface of a finger is brought into contact with the robot 300. Accordingly, the use of both the inertial sensor 120 and the touch sensor 110 has the following advantages.

First, sensor fusion (combination) makes it easy to eliminate noise.

Second, sensor fusion increases the number of types of recognizable touch actions. Especially, the number of types of recognizable touch actions is increased when the force sensor, rather than the on/off touch sensor, is used together with the inertial sensor.

Third, sensor fusion increases accuracy.

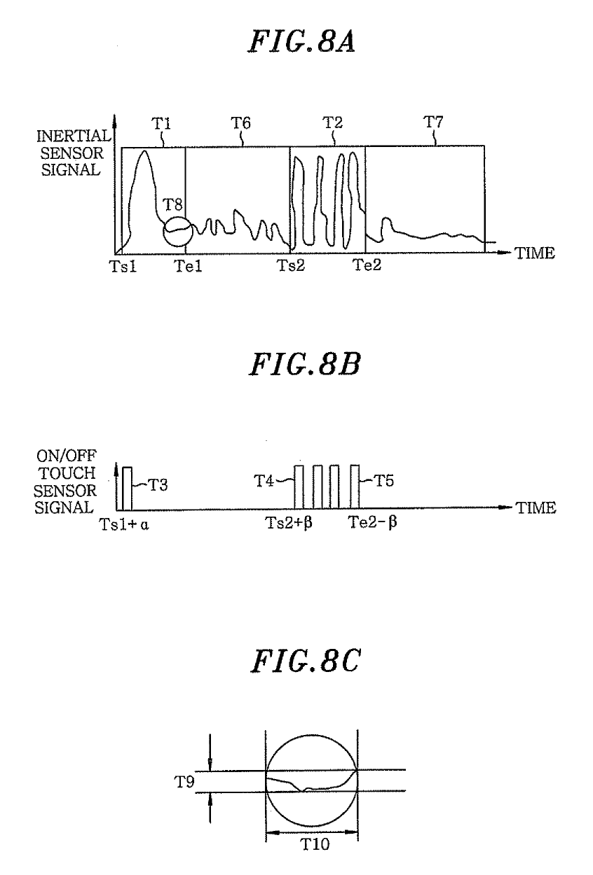

FIGS. 8A to 8C are graphs illustrating the advantage of noise removal when the inertial sensor is used together with the touch sensor in accordance with the embodiment of the invention.

In the following description, right hand fingers are sequentially (thumb first) denoted by R1, R2, R3, R4, and R5 and left hand fingers are sequentially (thumb first) denoted by L1, L2, L3, L4, and L5.

When the inertial sensor 120 is used alone, it is not easy to accurately identify, as noise, a signal generated when the hand moves in the air. However, if the inertial sensor 120 is used together with the touch sensor 110, the time when the touch sensor 110 is turned on can be set as a reference time to check validity of the inertial sensor 120 since it is known that the touch sensor 110 is turned on when a hand of a person touches the surface of the robot 300.

More specifically, FIG. 8A represents signals of the inertial sensor 120 attached to the finger R2 and FIG. 8B represents signals from the on/off touch sensor 110 attached to an inner surface (palm surface) of the finger R2. In FIG. 8A, T1 represents a “hit” signal, T2 represents a “tickle” signal, and T6 and T7 represent noise signals. If the information of FIG. 8A is provided alone, it is not easy to determine that the signals represented by T6 and T7 are noise. However, if the information of FIG. 8B is additionally provided, it significantly contributes to removing noise such as T6 or T7.

For example, when Ts1+α is the time when a T3 signal is generated, Ts1, which is α earlier than Ts1+α, can be determined to be a start time of a T1 signal generated by the inertial sensor 120. FIG. 8C, which is an expanded view of a T8 portion of FIG. 8A, illustrates how the end time of the T1 signal is determined. In the example of FIG. 8C, a change of the signal from the inertial sensor 120 per preset unit time is kept less than an experimentally predetermined threshold level (for example, T9) during more than a predetermined time (T10). The time when the predetermined time is reached is determined to be an end time (Te1) of the signal of the inertial sensor 120.

A T6 signal that the touch sensor 110 generates between the time Te1 and the time Ts2+β when a T4 signal generated by the touch sensor 110 is initially received, is regarded as noise. This is accomplished through fusion of the inertial sensor 120 and the touch sensor 110. When the touch sensor 110 is not used together with the inertial sensor 120, signals generated by the inertial sensor 120 during T6 are regarded as normal data rather than noise since the signals during T6 vary by more than a preset threshold level.

T2, T4, and T5 in FIGS. 8A and 8B are signals of the inertial sensor 120 and the touch sensor 110 corresponding to an embodiment of “tickle.” In the case of “tickle,” signals as shown in FIGS. 8A and 8B are generated since the fingers R2 and R3 repeatedly move. In this case, Ts2, which is β earlier than Ts2+β, can also be determined to be a start time of a T2 signal generated by the inertial sensor 120. Since the signal of the touch sensor 110 is continuously received, an end time Te2 of the T2 signal is determined based on the time Te2−β at which the last T5 of a plurality of peak signals that are continually received at intervals of less than a predetermined time is generated. The signal T7 is regarded as noise as in the case of T6.

As is apparent from the above description, using fusion of multiple sensors providing synergistic effects in accordance with the invention not only easily removes noise but also increases the number of types of recognizable touch actions, compared to the case of using only one type of sensor. Especially, using a force sensor rather than the simple on/off touch sensor 110 together with the inertial sensor 120 further increases the number of types of recognizable touch actions since it is possible to determine even the magnitude of force applied by each touch action. In addition, using additional information improves the accuracy of touch action recognition. For example, in the case of FIGS. 8A to 8C, the signals T1 and T7 are not vaguely defined but are rather more accurately identified as the information of T3, T4, and T5 is additionally used. This accuracy increase indicates that the number of recognizable touch actions is also increased.

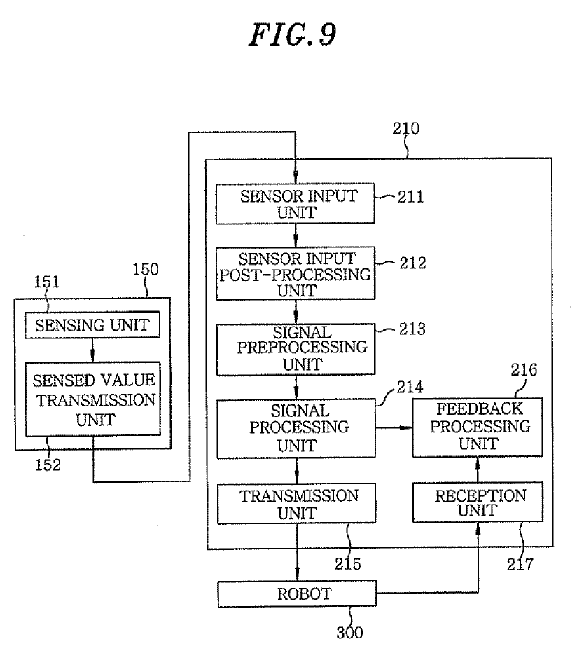

FIG. 9 is a block diagram illustrating details of the sensor processor module and the signal processor module in the touch action recognition system in accordance with the embodiment of the invention.

The sensor processor module 150 includes a sensing unit 151 and a sensed value transmission unit 152. The sensing unit 151 detects sensed values that the sensors 110, 120, and 140 generate as a hand of a person moves while the inertial sensor 120 alone is connected to the sensor board 100 or both the inertial sensor 120 and the touch sensor 110 are connected to the sensor board 100 or both the inertial sensor 120 and the optical sensor 140 are connected to the sensor board 100. The sensed value transmission unit 152 transmits data detected by the sensing unit 151 through the sensor interface 130 connected to the signal processing board 200.

The signal processor module 210 includes a sensor input unit 211, a sensor input post-processing unit 212, a signal preprocessing unit 213, a signal processing unit 214, a transmission unit 215, a feedback processing unit 216, and a reception unit 217. The sensor input unit 211 receives sensor data transmitted from the sensed value transmission unit 152 through the signal processing interface 220 connected to the sensor board 100. If received sensor values are analog, the sensor input post-processing unit 212 converts the analog values into digital values and normalizes all the digital values and then transfer the normalized digital values to a next processing unit. Upon receiving the normalized digital sensor values, first, the signal preprocessing unit 213 determines whether or not a reference sensor value of the touch sensor 110 or the optical sensor 140 is present. If a reference sensor value is present, the signal preprocessing unit 213 separates a valid data range(s) of the inertial sensor 120 from the normalized digital sensor values after removing noise with reference to the reference sensor value. If no reference sensor value is present, the signal preprocessing unit 213 separates a valid data range(s) of the inertial sensor 120 from the normalized digital sensor values using only the sensor value from the inertial sensor 120. The signal preprocessing unit 213 then extracts features from the separated valid data range from which noise has been removed for touch action recognition. The signal processing unit 214 compares the feature data received from the signal preprocessing unit 213 with prearranged reference data for similarity and determines whether or not reference data similar in a degree higher than a predetermined threshold level is present for determining a most similar touch action recognition class. The transmission unit 215 transfers the touch action recognition result of the robot 300, obtained by the signal processing unit 214, to the robot 300.

The signal processing board 200 also includes the feedback device 240 as described above with reference to FIG. 5. The feedback device 240 can be implemented so as to perform a corresponding feedback operation, predetermined according to the type of the touch action recognition result of the signal processing unit 214, and can also be implemented so as to perform a feedback operation according to a result of processing that the robot 300 performs upon receiving the touch action recognition result. In the former case, the signal processor module 210 includes the feedback processing unit 216 that controls the feedback device 240 according to the touch action recognition result of the robot 300 obtained by the signal processing unit 214 so as to perform a predetermined feedback operation corresponding to the touch action recognition result. In the latter case, the signal processor module 210 includes the reception unit 217 that receives the result of processing of the touch action recognition result from the robot 300 and the feedback processing unit 216 that controls the feedback device 240 according to the result of processing of the touch action recognition result of the robot 300 received through the reception unit 217 so as to perform a predetermined feedback operation corresponding to the processing result.

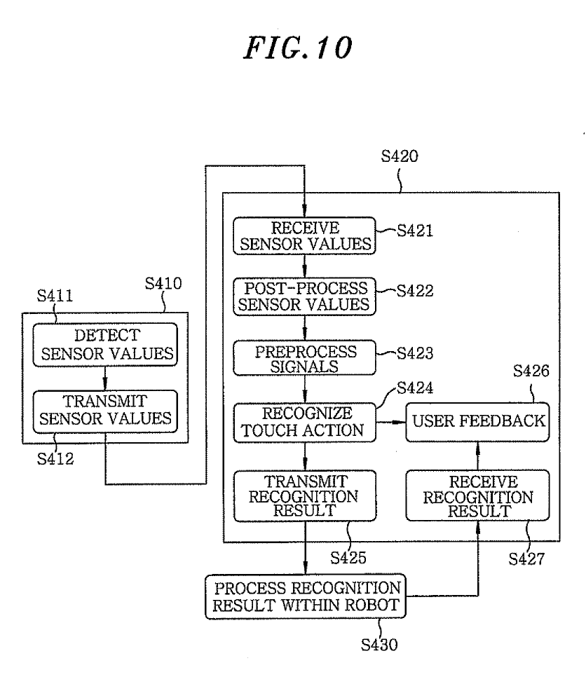

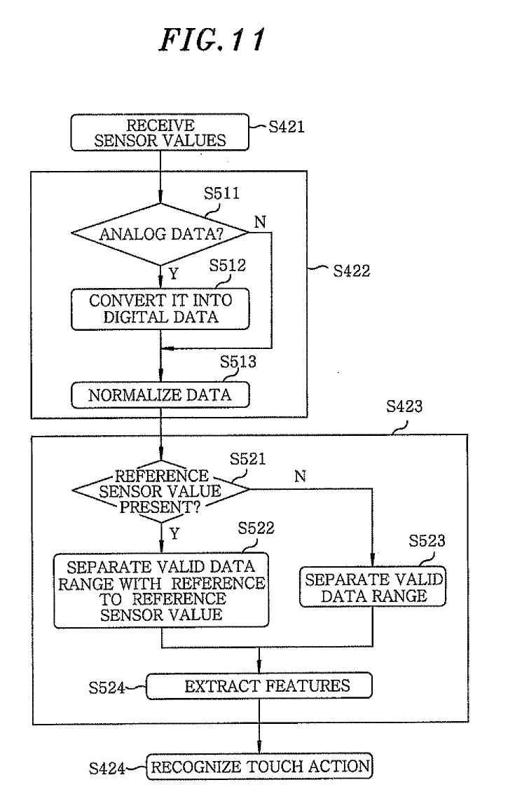

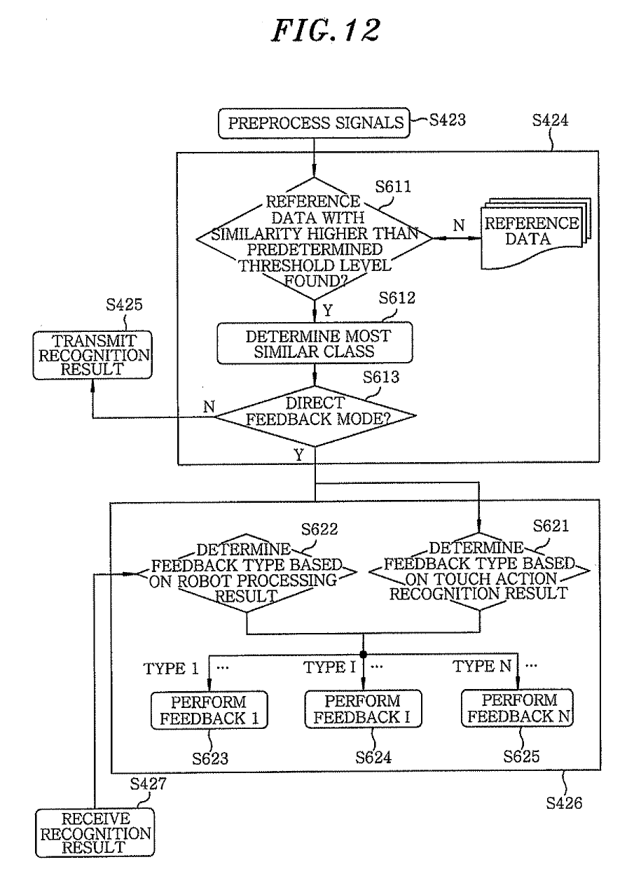

FIG. 10 is a flow chart illustrating a touch action recognition method in accordance with an embodiment of the invention, FIG. 11 is a flow chart illustrating in more detail post-processing and preprocessing processes shown in FIG. 10, and FIG. 12 is a flow chart illustrating in more detail touch action recognition and feedback processes shown in FIG. 10.

The touch action recognition method in accordance with the embodiment of the invention will now be described with reference to FIGS. 10 to 12.

As shown in FIG. 10, the touch action recognition method is performed in the following manner. First, at step S411, the sensor board 100 detects sensor values that the sensors 110, 120, and 140 generate as a hand of a person moves while the inertial sensor 120 alone is connected to the sensor board 100 or both the inertial sensor 120 and the touch sensor 110 are connected to the sensor board 100 or both the inertial sensor 120 and the optical sensor 140 are connected to the sensor board 100. Then, at step S412, the detected data is transmitted through the sensor interface 130 connected to the signal processing board 200. Then, at step S421, the signal processing board 200 receives sensor data transmitted from the sensor board 100 through the signal processing interface 220 connected to the sensor board 100. If received sensor values are analog, at step S422, post-processing is performed upon the sensor values by converting the analog values into digital values and normalizing all the digital values and then transferring the normalized digital values to a next process. When normalized digital sensor values are received, at step S423, signal preprocessing is performed in the following manner. First, it is determined whether or not a reference sensor value of the touch sensor 110 or the optical sensor 140 is present. If a reference sensor value is present, a valid data range(s) of the inertial sensor 120 is separated from the normalized digital sensor values after noise is removed with reference to the reference sensor value. If no reference sensor value is present, a valid data range(s) of the inertial sensor 120 is separated from the normalized digital sensor values using only the sensor value from the inertial sensor 120. Features are then extracted from the separated valid data range from which noise has been removed for touch action recognition. Then, at step S424, touch action recognition is performed by comparing the feature data received from the signal preprocessing unit 213 with prearranged reference data for similarity and determining whether or not reference data is similar in a degree higher than a predetermined threshold level is present for determining a most similar touch action recognition class. Then, at step S425, the touch action recognition result of the robot 300, obtained by the signal processing unit 214, is transferred to the robot 300. Then, at step S430, the robot 300 receives and processes the touch action recognition result of the robot 300 transmitted at step S425 according to a purpose preset within the robot 300.

The touch action recognition method also includes a feedback process allowing a person to physically feel the touch action recognition result or the result of processing performed by the robot 300. The feedback process can be implemented so as to perform a corresponding feedback operation, predetermined according to the type of the touch action recognition result obtained at step S424, and can also be implemented so as to perform a feedback operation according to a result of processing that the robot 300 performs upon receiving the touch action recognition result. In a direct feedback mode as in the former case, the feedback process includes, as a user feedback step, the step S426 of controlling the feedback device 240 according to the touch action recognition result of the robot 300 obtained at step S424 so as to perform a predetermined feedback operation corresponding to the touch action recognition result. In an indirect feedback mode as in the latter case, the feedback process includes the step S427 of receiving the result of processing of the touch action recognition result from the robot 300 and the step S426 of controlling the feedback device 240 in accordance with the result of processing of the touch action recognition result of the robot 300 so as to perform a predetermined feedback operation corresponding to the processing result. The step S410 including steps S411 and S412 in FIG. 10 is performed at the sensor board 100 and the step S420 including steps S421 to S427 in FIG. 10 is performed at the signal processing board 200.

The following is a more detailed procedure of the sensor value post-processing step S422. First, at step S511, it is determined whether sensor values received at step S421 are analog or digital data. If the sensor values are analog data, the analog data is converted into digital data at step S512 and the procedure proceeds to a data normalization step S513. If the sensor values are digital data, the procedure directly proceeds to the data normalization step S513. The received sensor values normalized at step S513 are then subjected to the signal preprocessing step S423.

The following is a more detailed procedure of the signal preprocessing step S423. When the normalized digital sensor values obtained at the sensor value post-processing step S422 are received, it is determined at step S521 whether or not a reference sensor value of a sensor such as the touch sensor 110 or the optical sensor 140, which is information used to eliminate noise of the inertial sensor 120, is present. If a reference sensor value is present, a valid data range(s) of the inertial sensor 120 is separated from the normalized digital sensor values with reference to the reference sensor value at step S522. If no reference sensor value is present, a valid data range(s) of the inertial sensor 120 is separated from the normalized digital sensor values using only the sensor value from the inertial sensor 120 at step S523. After the valid data range(s) of the inertial sensor 120 is separated from the normalized digital sensor values, data features for the touch action recognition step S424 are extracted using both the separated information of the inertial sensor 120 and the reference sensor value (if any) at step S524. If data features are extracted for the touch action recognition step S424, then the touch action recognition step S424 is performed using the extracted features.

The following is a more detailed procedure of the touch action recognition step S424 and the user feedback step S426. First, at step S611, the feature extracted at the signal preprocessing step S423 is compared with a plurality of prearranged reference data items for similarity. If some of the plurality of prearranged reference data items have a similarity higher than a predetermined threshold level, the class of touch action recognition is determined to be the same as that of a reference data item having the highest similarity among the reference data items having the higher similarity at step S612. No processing is performed if none of the reference data items has a higher similarity than the predetermined threshold level.

If the most similar touch action recognition class is determined, it is determined whether the current feedback mode is the direct feedback mode or the indirect feedback mode at step S613. Further, a user or program may predetermine whether the current feedback mode is the direct feedback mode or the indirect feedback mode. If it is determined that the current feedback mode is the direct feedback mode, the type of feedback to be applied is determined according to the result of touch action recognition at step S621 and a predetermined feedback operation is performed according to the determined type of feedback. More specifically, a feedback operation 1 is performed if the determined feedback type is Type 1 (S623), a feedback operation I is performed if the feedback type is Type I (S624), and a feedback operation N is performed if the feedback type is Type N (S625). If it is determined at step S613 that the current feedback mode is the indirect feedback mode, the recognition result is transmitted to the robot 300 at step S425.

At the user feedback step S426, a feedback operation can also be performed according to the result of processing at the robot 300. In this case, the result of processing at the robot 300 is received at step S427, and the type of feedback to be applied is determined according to the processing result at step S622 and a predetermined feedback operation is performed according to the determined type of feedback. More specifically, a feedback operation 1 is performed if the determined feedback type is Type 1 (S623), a feedback operation I is performed if the feedback type is Type I (S624), and a feedback operation N is performed if the feedback type is Type N (S625).

As is apparent from the above description, the present invention provides a touch action recognition system and method with a variety of features and advantages. For example, there is no need to initially attach sensors to a robot and it is possible to exactly determine whether an object or a hand of a person has touched the robot. In the case of an object with a skin, the skin does not cause erroneous recognition. It is also possible to recognize a wide variety of touch actions.

While the invention has been shown and described with respect to the preferred embodiments, it will be understood by those skilled in the art that various changes and modifications may be made without departing from the spirit and scope of the invention as defined in the following claims.

What is claimed is:

1. A system for recognizing a touch action that a person has performed upon an object, the system comprising:
a sensor component for detecting a sensor value corresponding to the touch action through an inertial sensor attached to part of a body of the person; and
a signal processing component for recognizing the touch action from the sensor value detected by the sensor component and transferring the recognized touch action to the object.

2. The system in accordance with claim 1, wherein the sensor component is a touch sensor or an optical sensor that generates a sensor value corresponding to the touch action together with the inertial sensor.

3. The system in accordance with claim 2, wherein the sensor component includes:
a sensor processor that reads the sensor value from the inertial sensor alone, or from both the inertial sensor and the touch sensor, or from both the inertial sensor and the optical sensor; and
a sensor interface that provides a path for transferring the sensor value read through the sensor processor to the signal processing component.

4. The system in accordance with claim 1, wherein the signal processing component includes:
a signal processing interface that provides a path for receiving the sensor value from the sensor component;
a signal processor that recognizes the touch action according to a comparison result of feature data extracted from the sensor value received through the signal processing interface with prearranged reference data; and
a communication channel for transferring a touch action recognition result obtained by the signal processor to the object.

5. The system in accordance with claim 4, wherein the signal processing component allows the person to physically feel the touch action recognition result.

6. The system in accordance with claim 5, wherein the signal processor includes:
a sensor input post-processing unit that converts, when sensor values received from the sensor component are analog values, the analog values into digital values and normalizes all the digital values and outputs the normalized digital values;
a signal preprocessing unit that receives the normalized digital values from the sensor input post-processing unit and separates a valid data range from the normalized digital values and extracts a feature from the separated valid data range; and
a signal processing unit that compares feature data received from the signal preprocessing unit with the prearranged reference data for similarity, determines whether or not reference data with a higher similarity than a predetermined threshold level is present, and determines a most similar touch action recognition class to recognize the touch action.

7. The system in accordance with claim 6, wherein the signal preprocessing unit determines whether or not a reference sensor value of a touch sensor or a optical sensor is present in the normalized digital values and separates the valid data range after removing noise with reference to the reference sensor value if the reference sensor value is present and separates the valid data range using only the sensor value from the inertial sensor if no reference sensor value is present.

8. The system in accordance with claim 6, wherein the signal processor controls the feedback device according to the touch action recognition result obtained by the signal processing unit to perform a predetermined feedback operation corresponding to the touch action recognition result.

9. The system in accordance with claim 5, wherein the signal processor further includes:
a reception unit that receives a result of processing of the touch action recognition result from the object; and
a feedback processing unit that controls the feedback device according to the processing result received through the reception unit to perform a predetermined feedback operation corresponding to the processing result.

10. A method for recognizing a touch action that a person has performed upon an object, the method comprising:
detecting a sensor value corresponding to the touch action through an inertial sensor attached to part of a body of the person; and
recognizing the touch action from the detected sensor value and transferring the recognized touch action to the object.

11. The method in accordance with claim 10, wherein the detecting a sensor value includes detecting a sensor value corresponding to the touch action using a touch sensor or an optical sensor that generates the sensor value together with the inertial sensor.

12. The method in accordance with claim 10, wherein the recognizing the touch action and transferring the recognized touch action includes recognizing the touch action according to a comparison result of feature data extracted from the sensor value received through a signal processing interface with prearranged reference data.

13. The method in accordance with claim 12, wherein the recognizing the touch action and transferring the recognized touch action includes:
performing sensor input post-processing by converting, when sensor values received from the sensor component are analog values, the analog values into digital values and normalizing all the digital values and outputs the normalized digital values;
performing signal preprocessing by separating a valid data range from the normalized digital values and extracting a feature from the separated valid data range; and
comparing feature data extracted at the performing signal preprocessing with the prearranged reference data for similarity, determining whether or not reference data with a higher similarity than a predetermined threshold level is present, and determining a most similar touch action recognition class to recognize the touch action.

14. The method in accordance with claim 13, wherein the performing signal preprocessing includes determining whether or not a reference sensor value of a touch sensor or a optical sensor is present in the normalized digital values and separating the valid data range after removing noise with reference to the reference sensor value if the reference sensor value is present and separating the valid data range using only the sensor value from the inertial sensor if no reference sensor value is present.

15. The method in accordance with claim 10, further comprising:
performing a predetermined corresponding feedback operation according to the touch action recognition result obtained at the recognizing the touch action to allow the person to physically feel the touch action recognition result.

16. The method in accordance with claim 10, further comprising:
receiving a result of processing of the touch action recognition result from the object, and
performing a predetermined corresponding feedback operation according to the processing result received at the receiving a result to allow the person to physically feel the processing result.
